(19) United States
(12) Patent Application Publication
(10) Pub. No.: US 2008/0204581 A1
(43) Pub. Date: Aug. 28, 2008

(54) Image capturing apparatus

(75) Inventors: Makoto Tsugita, Tokyo (JP); Takeshi Misawa, Saitama-shi (JP); Atsushi Misawa, Niiza-shi (JP); Hiroshi Tanaka, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/071,652

(22) Filed: Feb. 25, 2008

(30) Foreign Application Priority Data
Feb. 28, 2007 (JP) 2007-050159

(51) Int. Cl. H04N 5/228; G06K 9/00

(52) U.S. Cl. 348/273; 382/167

(57) ABSTRACT

When a selected target color space for a digital camera is changed, the colors of a final image, i.e., the colors of an image in the changed target color space, are predicted from an image that is displayed on a display unit of the digital camera. For example, if the target color space is changed to an sRGB color space and the display unit has an AdobeRGB color space, then an image in the target color space (the sRGB color space), which is generated from a captured image by a signal processor, is converted by a matrix calculator into an image in the AdobeRGB color space, and then the image is supplied to the display unit. Hence, the colors of the final image can be predicted from the colors of the image displayed on the display unit.

### BACKGROUND OF THE INVENTION

1. Field of the Invention

The present invention relates to an image capturing apparatus, which is capable of selecting a target color space and/or a display color space.

2. Description of the Related Art

Heretofore, many image capturing apparatus such as digital cameras or the like have been able to display images, which are being captured or have been captured, on the liquid crystal display screen on the apparatus body.

There have been proposed image capturing apparatus that are capable of switching between different image capturing modes, e.g., a still image capturing mode, an NTSC moving image capturing mode, and a high-definition moving image capturing mode.

An image capturing apparatus capable of selecting a target color space has also been proposed (Japanese Laid-Open Patent Publication No. 2004-096400).

Furthermore, a technology for converting between different color spaces has also been proposed (Japanese Laid-Open Patent Publication No. 2001-136543).

There has also been proposed an image capturing apparatus, which is able to select an optimum color space for a captured image (Japanese Laid-Open Patent Publication No. 2004-080737).

However, the image capturing apparatus disclosed in Japanese Laid-Open Patent Publication No. 2004-096400 does not take into account the conformity of colors between the image output to an output device (monitor) as a target and the image displayed on the display unit of the image capturing apparatus.

The technology disclosed in Japanese Laid-Open Patent Publication No. 2001-136543 also does not take into account the color space of the image that is displayed on the display unit of the image capturing apparatus.

According to the image capturing apparatus disclosed in Japanese Laid-Open Patent Publication No. 2004-080737, when colors of a captured image exceed the color range of a target color space, the display unit displays information indicating that the colors of the captured image exceed the color range. However, as with the image capturing apparatus disclosed in Japanese Laid-Open Patent Publication No. 2004-096400, the image capturing apparatus disclosed in Japanese Laid-Open Patent Publication No. 2004-80737 does not take into account the conformity of colors between the output image and the image displayed on the display unit.

According to the above technologies of the related art, although an image can be captured while the target color space is being selected, an image on the display unit gives no consideration to the color reproducibility of the image displayed on the display unit (Japanese Laid-Open Patent Publication No. 2004-096400, Japanese Laid-Open Patent Publication No. 2001-136543), or alternatively, an image with color reproducibility optimum for the display unit is displayed (Japanese Laid-Open Patent Publication No. 2004-080737). Therefore, it is highly difficult to predict, from an image on the display unit, the color reproducibility of a final image in the target color space.

### SUMMARY OF THE INVENTION

It is an object of the present invention to provide an image capturing apparatus, which is capable of predicting the color reproducibility of a final image that changes by selecting a target color space, with respect to an image of a subject captured by an image capturing unit.

Another object of the present invention is to provide an image capturing apparatus, which is capable of predicting, on a display unit, the color reproducibility of a final image that changes when the target color space is switched.

An image capturing apparatus according to the present invention comprises an image capturing unit for capturing an image of a subject, a target color space selector for selecting a target color space, a signal processor for converting the image captured by the image capturing unit into an image in the target color space selected by the target color space selector, a display color space selector for selecting a display color space, a comparator for comparing the target color space selected by the target color space selector and the display color space selected by the display color space selector with each other in order to determine whether or not the target color space and the display color space are identical to each other, and a calculator for converting the image in the target color space into an image in the display color space if the comparator judges that the target color space selected by the target color space selector and the display color space selected by the display color space selector are different from each other.

With the above image capturing apparatus, after a captured image is converted into an image in the selected target color space, if it is judged that the target color space and the display color space are different from each other, then the image in the target color space is converted into an image in the display color space. Therefore, the colors of the final image in the selected target color space can be predicted from the image (displayed image) in the display color space. Stated otherwise, the color reproducibility in the target color space can be predicted from the displayed image.

Another image capturing apparatus according to the present invention comprises an image capturing unit for capturing an image of a subject, an image capturing mode selector for selecting one of image capturing modes in different target color spaces, a signal processor for converting the image captured by the image capturing unit into an image in the target color space corresponding to the image capturing mode selected by the image capturing mode selector, a display color space selector for selecting a display color space, a comparator for comparing the target color space corresponding to the image capturing mode selected by the image capturing mode selector and the display color space selected by the display color space selector with each other in order to determine whether or not the target color space and the display color space are identical to each other, and a calculator for converting the image in the target color space into an image in the display color space selected by the display color space selector if the comparator judges that the target color space corresponding to the image capturing mode selected by the image capturing mode selector and the display color space selected by the display color space selector are different from each other.

With the above image capturing apparatus, after a captured image is converted into an image in a target color space corresponding to the image capturing mode selected by the image capturing mode selector, if it is judged that the target color space corresponding to the image capturing mode selected by the image capturing mode selector and the display color space selected by the display color space selector are different from each other, then the image in the target color space is converted into an image in the display color space selected by the display color space selector. Therefore, the colors of the final image in the target color space, which correspond to the selected image capturing mode, can be predicted from the image (displayed image) in the display color space. Stated otherwise, the color reproducibility in the target color space of the selected image capturing mode can be predicted from the displayed image.

The selected image capturing mode may be one of a still image capturing mode, an NTSC moving image capturing mode, and a high-definition moving image capturing mode.

The image capturing apparatus may further comprise a detachable lens unit having lens identifying information for identifying the lens unit. The image capturing mode selector may select one of the image capturing modes based on the lens identifying information. The image capturing mode matching the detachable lens unit can thus be selected automatically.

The image in the target color space may be stored in a storage unit.

The image in the target color space may be output from an output terminal. The image capturing apparatus may have a display unit for displaying images that have been converted into the color space of the display unit.

The display unit may have identifying information for identifying the display unit, and may be detachably mounted. The display color space selector may select the display color space based on the identifying information of the display unit. The display color space can thus be selected automatically. In other words, the image in the target color space may be displayed on the display unit, without the need for the user to be concerned about the display color space of the display unit.

According to the present invention, the user can predict the colors of the final image in the selected target color space from the displayed image on the display unit. Stated otherwise, the color reproducibility in the target color space can be predicted from the displayed image.

When the target color space is changed, the color reproducibility of a correspondingly changed final image can be predicted from the image displayed on the display unit.

When the detachable lens unit is mounted on the image capturing apparatus, the image capturing mode matching the mounted detachable lens unit is selected automatically.

When the detachable display unit is mounted on the image capturing apparatus, the image in the target color space corresponding to the display color space of the display unit can be displayed automatically on the display unit.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of an image capturing apparatus according to an embodiment of the present invention;

FIG. 2A is a perspective view of the image capturing apparatus, which includes a detachable display unit such as a color liquid crystal display unit or the like;

FIG. 2B is a perspective view of the image capturing apparatus with the detachable display unit being removed from the apparatus housing;

FIG. 3 is a block diagram of an image capturing apparatus according to a modification of the image capturing apparatus shown in FIG. 1;

FIG. 4 is a diagram showing the types of color spaces on an xy chromaticity diagram;

FIG. 5 is a flowchart (1) of an operation sequence of the image capturing apparatus shown in FIG. 1;

FIG. 6 is a flowchart (2) of an operation sequence of the image capturing apparatus shown in FIG. 1;

FIG. 7 is a view showing a screen for selecting (specifying) a target color space;

FIG. 8 is a block diagram of an image capturing apparatus according to another embodiment of the present invention;

FIG. 9 is a flowchart (1) of an operation sequence of the image capturing apparatus shown in FIG. 8;

FIG. 10 is a view showing a screen for selecting (specifying) an image capturing mode;

FIG. 11 is a diagram showing the types of color spaces on an xy chromaticity diagram;

FIG. 12 is a flowchart (2) of an operation sequence of the image capturing apparatus shown in FIG. 8; and

FIG. 13 is a block diagram of an image capturing apparatus according to still another embodiment of the present invention.

### DESCRIPTION OF THE PREFERRED EMBODIMENTS

Preferred embodiments of the present invention shall be described below with reference to the accompanying drawings.

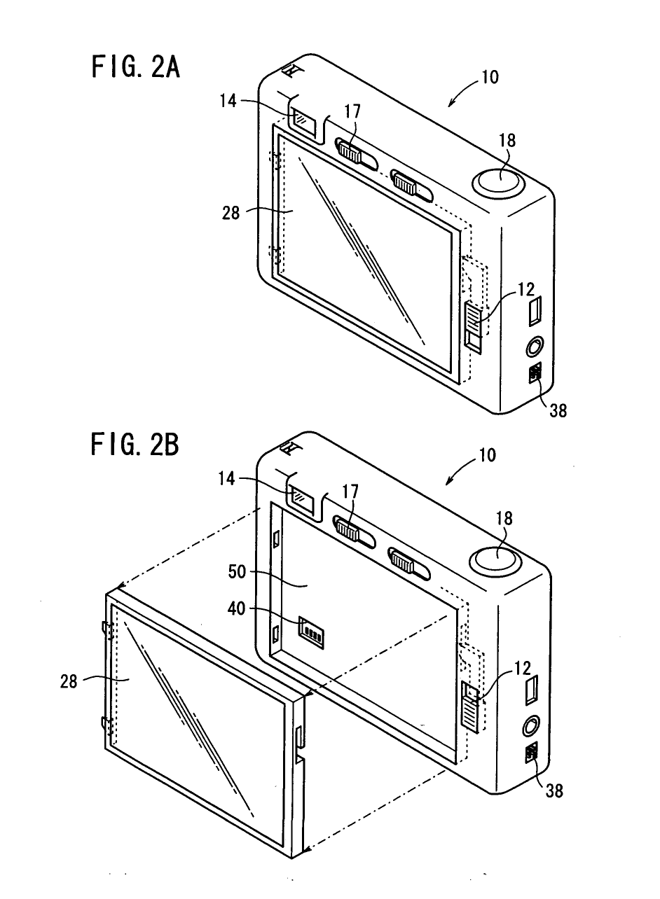

FIG. 2A is a perspective view of an image capturing apparatus 10 according to an embodiment of the present invention, which includes a detachable display unit 28 such as a color liquid crystal display unit or the like. In the present embodiment, the image capturing apparatus 10 is in the form of a portable digital camera.

FIG. 2B is a perspective view of the image capturing apparatus 10, with the detachable display unit 28 being removed from an apparatus housing 50.

The image capturing apparatus 10 includes a lens, etc., on the front face thereof (not shown), and also has, on a rear face, the display unit 28, which can be removed by a mounting/removing mechanism 12, a viewfinder 14, and a menu key for determining the display and for selection of a menu. Since a target color space is selected by operating the menu key, the menu key will be referred to as a target color space selector 17.

The image capturing apparatus 10 also has a shutter key 18 on an upper face thereof.

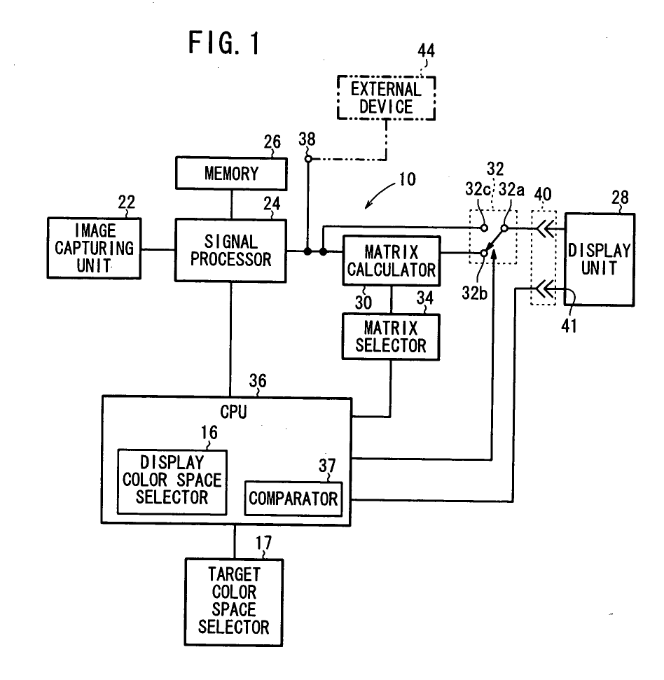

FIG. 1 shows in block form an electric and optical system of the image capturing apparatus 10 shown in FIG. 2B.

As shown in FIG. 1, the image capturing apparatus 10 comprises a CPU 36 for executing programs stored in a ROM in order to perform various functions, an image capturing unit 22 comprising lenses, a CCD image capturing element, etc., for capturing an image of a subject, the target color space selector 17 for selecting a target color space, a signal processor 24 for converting an image (digital data) captured by the image capturing unit 22 into an image (digital data) in the target color space selected by the target color space selector 17, a memory 26 serving as a storage unit for storing the image (digital data) in the target color space, a display color space selector 16, which is a function performed by the CPU 36, for selecting a display color space defining characteristics of the display unit 28, a comparator 37, which is a function performed by the CPU 36, for comparing the target color space selected by the target color space selector 17 and the display color space selected by the display color space selector 16 with each other in order to determine whether or not they are identical to each other, a matrix calculator (calculator) 30 for converting the image in the target color space into the image in the display color space if the comparator 37 judges that the target color space selected by the target color space selector 17 and the display color space selected by the display color space selector 16 are different from each other, a switcher 32 that outputs, through a connector 40 to the display unit 28, the image (digital data) in the target color space output from the signal processor 24, or the image (digital data) in the display color space output from the matrix calculator 30, and a matrix selector 34 for selecting a matrix from among matrices set in the matrix operator 30. The CPU 36 controls all these components, which make up the image capturing apparatus 10.

The switcher 32 comprises a selector for connecting a common port 32a to a port 32b or to a port 32c, based on a control signal from the CPU 36.

In the present embodiment, the display unit 28, which is connected to the image capturing apparatus 10 by the connector 40 when it is placed in the apparatus housing 50 (see FIG. 2B) and mounted on the image capturing apparatus 10, has an AdobeRGB color space as the display color space. The display unit 28 can be replaced with a display unit 28 having characteristics representative of another color space, such as an sRGB color space or the like, for example, by operating the mounting/removing mechanism 12.

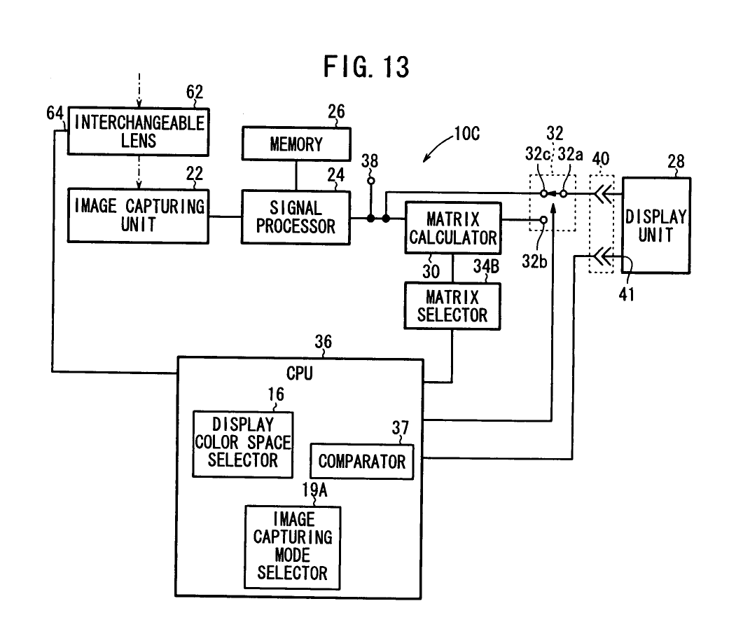

The color space, which the display unit 28 has as its characteristics, is automatically identified by the display color space selector 16 of the CPU 36 through the connector 40. Specifically, similar to an interchangeable lens to be described later with reference to FIG. 13, the connector 40 of the display unit 28 has an identifier 41 for identifying the color space of the display unit 28. When the CPU 36, which functions as the display color space selector 16, reads information from the identifier 41 of the display unit 28 that is placed in the apparatus housing 50, the CPU 36 functions as the display color space selector 16.

Specifically, the display color space of the display unit 28, which has been read from the identifier 41 through the connector 40, becomes the display color space selected by the display color space selector 16. The image capturing apparatus 10 may be modified such that the display color space selector 16 is provided as an external console unit of the image capturing apparatus 10, as is the case with the target color space selector 17, whereby the display color space selector 16 thus provided selects a display color space.

It should be noted that the image in the target color space output from the signal processor 24 has been converted from the image captured by the image capturing unit 22, and further, that the image output from the matrix calculator 30 has been converted from the image in the target color space into the image in the display color space.

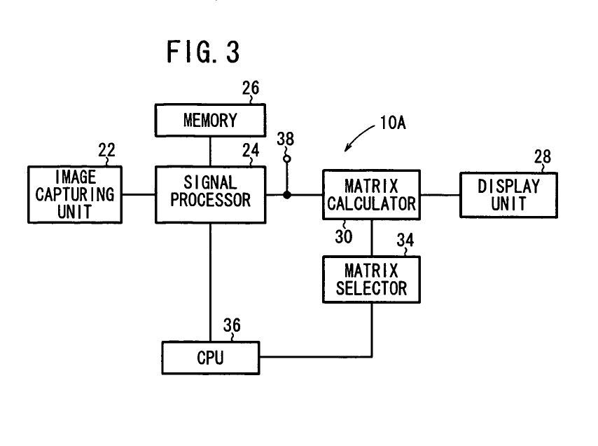

If the display unit 28 is not replaceable, but is fixed to the image capturing apparatus 10, and the target color space and the display color space of the display unit 28 are identical to each other, then the image capturing apparatus 10 may be constructed as the image capturing apparatus 10A shown in FIG. 3. In the image capturing apparatus 10A, the matrix selector 34 selects a unit matrix, i.e., a matrix whose input and output are equal to each other, and sets the unit matrix in the matrix calculator 30. The display unit 28 displays an image, which is identical to the image, in the target color space that is output from the signal processor 24. The image capturing apparatus 10A does not include the switcher 32 and other associated components of the image capturing apparatus 10 shown in FIG. 1.

In FIG. 1, the output terminal of the signal processor 24 is connected to an output port (output terminal) 38 (see also FIGS. 2A and 2B), for outputting an image (digital data) in the target color space that is generated by the signal processor 24 and stored in the memory 26 to an external device 44, such as an external display unit or the like.

The CPU 36 includes a ROM, a RAM, etc., in addition to the processor thereof. When the processor executes programs stored in the ROM, the CPU 36 operates as a function performing means, such as the comparator 37, for comparing the target color space selected by the target color space selector 17 and the display color space selected by the display color space selector 16 with each other, in order to determine whether or not they are identical to each other.

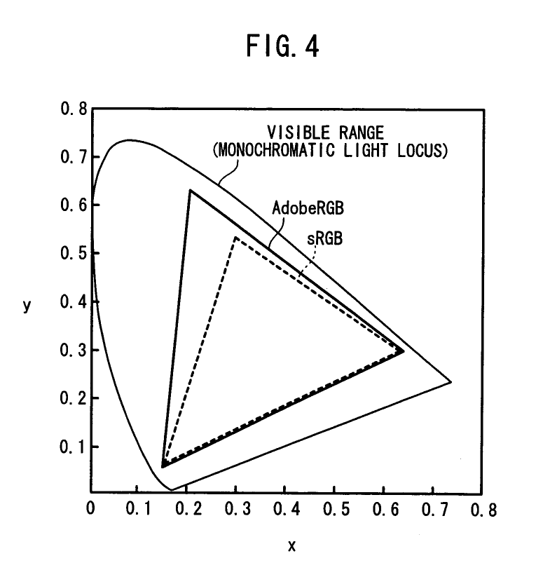

FIG. 4 shows the types of color spaces (also referred to as “color gamuts”) on an xy chromaticity diagram. In FIG. 4, the color space plotted in the shape of a horseshoe by thin solid lines represents a visible range (monochromatic light locus), which is a color gamut including all expected colors, whereas the color space plotted by thick solid lines represents the range of an AdobeRGB color space. The color space plotted by thick dotted lines represents an sRGB color space.

In the image capturing apparatus 10 shown in FIG. 1, as well as in FIGS. 2A and 2B, the target color space selector 17 can select a color space, which may be any of the AdobeRGB color space, the sRGB color space, or a grayscale based B/W (monochromatic) color space.

The sRGB color space, which was established in 1999, does not contain highly saturated greenish colors therein, although such colors have become available for display due to advances in the display monitor technology after its establishment. The AdobeRGB color space is defined to contain such highly saturated greenish colors, which can be displayed by display monitors in recent years.

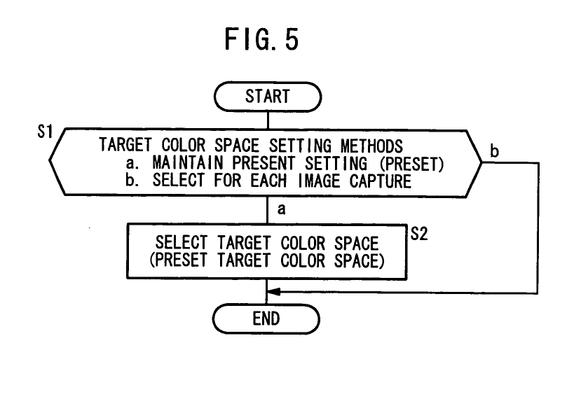

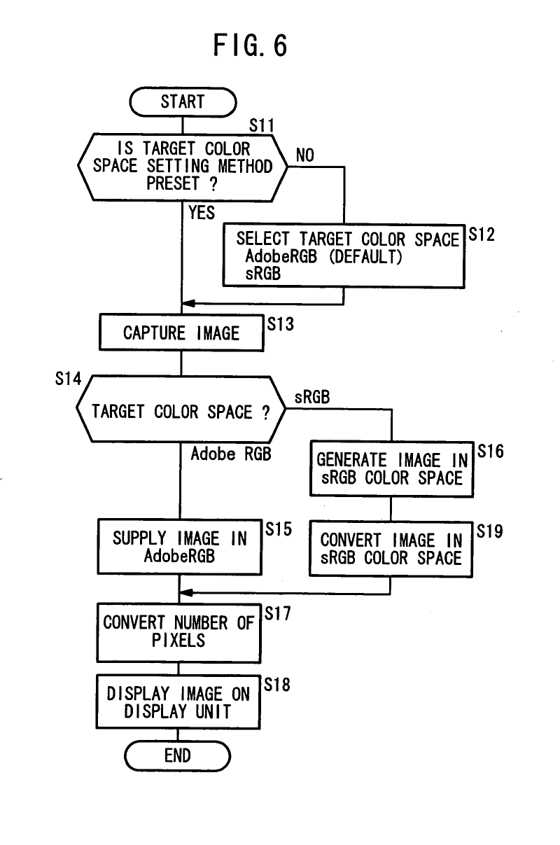

Operation of the image capturing apparatus 10 will be described below with reference to the flowcharts shown in FIGS. 5 and 6. Although the CPU 36 executes the program represented by the flowcharts, in the description of these flowcharts, the CPU 36 will be referred to only when required.

Before the image capturing unit 22 captures an image of a subject, a method of setting a target color space in the signal processor 24 is selected using the target color space selector 17. There are two selectable methods of setting the target color space, i.e., “a. MAINTAIN PRESENT SETTING (PRESET)” and “b. SELECT FOR EACH IMAGE CAPTURE”.

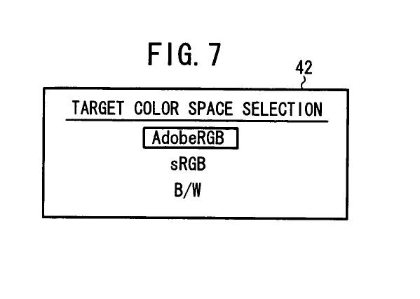

If “a. MAINTAIN PRESENT SETTING (PRESET)” is selected in step S1, then a target color space is selected using the target color space selector 17 and is preset in step S2. Specifically, the user operates the target color space selector 17 to display a screen 42 (see FIG. 7) for selecting (specifying) a target color space on the display unit 28. After a preset target color space is selected, the method of setting the target color space is finished. In FIG. 7, “AdobeRGB”, “sRGB”, and “B/W” are displayed for selection on the screen 42.

When the user determines the target color space displayed on the screen 42 using the target color space selector 17, for example, “AdobeRGB” surrounded by a rectangular frame is preset as the target color space. In FIG. 7, the three types of target color spaces are displayed on the screen 42. However, the target color spaces are not limited to these three types, but may additionally include an xvYCC color space, for example.

If “b. SELECT FOR EACH IMAGE CAPTURE” is selected in step S1, then a target color space is not preset, and the method of setting the target color space is finished.

When the image capturing unit 22 actually captures an image of a subject, as shown in FIG. 6, it is determined whether or not a target color space has been preset in step S11. If step S2 is not carried out, and if no target color space has been preset, then the target color space selector 17 displays the screen 42 shown in FIG. 7 on the display unit 28. The user selects either “AdobeRGB” (default) or “sRGB”, for example, as a target color space, i.e., a color space for the image (digital data) generated by the signal processor 24 and stored in the memory 26, and a color space for the image (digital data) to be output from the output port 38, when necessary.

In step S13, the user presses the shutter key 18 to capture an image of the subject.

In step S14, the selection (characteristics) of the target color space is confirmed, and the target color space is compared with the display color space of the display unit 28. As described above, the display unit 28 connected to the image capturing apparatus 10 has an AdobeRGB color space as the display color space.

If the AdobeRGB color space is selected as the target color space for recording the image in the memory 46 or for outputting the image from the output port 38 to the external device 44 in step S14, then since the target color space and the display color space are identical to each other, the common port 32a of the switcher 32 is connected to the port 32c that is connected directly to the signal processor, and the image (digital data) in the AdobeRGB color space is supplied as a to-be-displayed image (digital data) from the signal processor 24 to the display unit 28.

At this time, in step S17, the image (digital data) in the display color space, which has been decimated by a pixel number converter (provided in the signal processor 24 and/or the display unit 28), is supplied as a to-be-displayed image (digital data) to the display unit 28. In step S18, the to-be-displayed image (picture) based on the image (digital data) in the AdobeRGB color space, which is generated by the signal processor 24, is displayed on the display unit 28 having the AdobeRGB color space. In this manner, the image in the AdobeRGB color space, which is selected as the target color space, is displayed on the display unit 28 having the AdobeRGB color space.

In step S14 (S2, S12), if the sRGB color space, which is different from the AdobeRGB color space, is selected as the target color space for storing the image in the memory 26 or for outputting the image from the output port 38 to the external device 44, then since the target color space and the display color space are different from each other, the CPU 36 controls the signal processor 24 so as to generate an image (digital data) in the sRGB color space as the target color space from the captured image (digital data), and to store the generated image in the memory 26.

Since the display unit 28 has an AdobeRGB color space, if the image (digital data) in the sRGB color space generated by the signal processor 24 is supplied without modification to the display unit 28, then the image is displayed in colors different from the colors that will be produced when the image is output to an sRGB monitor, which has been provided, as desired by the user, as the external device 44.

To solve the above problem, in step S19, the CPU 36 controls the matrix selector 34 to select a matrix, for causing the colors produced when the image is output to the external device 44 as a target-color-space-display unit having the sRGB color space, to be seen approximately (predicted) on the display unit 28, which has the AdobeRGB color space, and to set the selected matrix in the matrix calculator 30.

A specific example of the matrix set in the matrix calculator 30 will be described below. If the three primary colors of an image (digital data) in the sRGB color space, which is input to the matrix, are represented by RGB (indicated as a three-row, one-column: matrix [I]), and the three primary colors of an image (digital data) in the AdobeRGB color space, which is output from the matrix, are represented by R′G′B′ (indicated as a three-row, one-column: matrix [I′]), then the matrix is expressed by equations (1) and (2) below. Equation (2) is described as an expansion of the determinant of the equation (1). The coefficients A11, A12, A13, A21, A22, A23, A31, A32 and A33 (hereinafter referred to as [A]) of a conversion three-row, three-column matrix may be generated in advance and stored in the ROM.

[I′]=[A][I] (1)

R′=A11·R+A12·G+A13·B

G′=A21·R+A22·G+A23·B

B′=A31·R+A32·G+A33·B (2)

Since the switcher 32 has been switched to connect the common port 32a to the port 32b as shown in FIG. 1, in step S19, the matrix calculator 30 converts the image (digital data: R, G, B) in the target color space generated by the signal processor 24 into a to-be-displayed image (digital data: R′, G′, B′) which approximates the AdobeRGB color space, based on the equations (1) and (2) above. After the number of pixels of the converted image has been converted in step S17, the image is supplied to the display unit 28.

According to the above control process, even if the image capturing apparatus 10 having the display unit 28 for expressing the AdobeRGB color space captures an image having an sRGB color space as the target color space, the resultant colors (i.e., the colors to be expressed on the sRGB monitor as the external device 44) can be reproduced and confirmed on the display unit 28 in step S18.

According to the present embodiment described above, as shown in FIG. 1, the image capturing apparatus 10 includes the target color space selector 17, the signal processor 24 for generating an image (digital data) in a target color space selected by the target color space selector 17, and the display unit 28. The comparator 37 compares the target color space selected by the target color space selector 17 with the display color space of the display unit 28 in order to determine whether or not they are identical to each other (step S14). If it is judged that the target color space (e.g., the sRGB color space) selected by the target color space selector 17 and the display color space (e.g., the AdobeRGB color space) of the display unit 28 are different from each other, then the matrix calculator 30 converts the image (digital data) in the sRGB color space into an image (digital data) in the display color space (AdobeRGB color space) of the display unit 28, and the display unit 28 displays the converted image.

As described above, the display unit 28 displays the image in the target color space selected by the target color space selector 17. Therefore, when the selected target color space is changed by the target color space selector 17, if the changed target color space and the color space of the display unit 28 are identical to each other, then the switcher 32 connects the common port 32a to the port 32c, so as to supply the image output from the signal processor 24 directly to the display unit 28 through the ports 32c, 32a and the connector 40. On the other hand, if the changed target color space and the color space of the display unit 28 are different from each other, then the switcher 32 connects the common port 32a to the port 32b to supply the image in the display color space, which is converted from the image in the target color space from the signal processor 24 by the matrix processor 30, to the display unit 28 through the ports 32b, 32a and the connector 40. Therefore, even when the selected target color space is changed, the colors in the final image, i.e., the colors of the image in the target color space, can be predicted from the image displayed on the display unit 28. Stated otherwise, the color reproducibility of the image in the target color space can be predicted from the image displayed on the display unit 28.

The image capturing apparatus 10 can display, on the display unit 28, a moving image while it is being captured, a still image that has been captured, or a captured image, in the target color space that corresponds to a moving image.

If the display unit 28 is a display monitor corresponding to the sRGB color space, i.e., capable of displaying an image in the sRGB color space only, then when the signal processor 24 generates an image (digital image) in the AdobeRGB color space as the target color space, some of the colors of the image in the sRGB color space cannot be displayed on the display unit 28. However, the display unit 28 is not incapable displaying all the colors of the subject. The display unit 28 may be able to display most of the colors of the subject, or may be able to display all of the colors, depending on the type of subject. Accordingly, if matrix coefficients similar to those of the equation (1) are generated in advance, and the image (digital data) in the AdobeRGB color space is converted by the matrix calculator 30, then the image (digital data) in the AdobeRGB color space can still be reproduced on the display unit 28 having the sRGB color space, in order for the user to confirm the tendency of the colors.

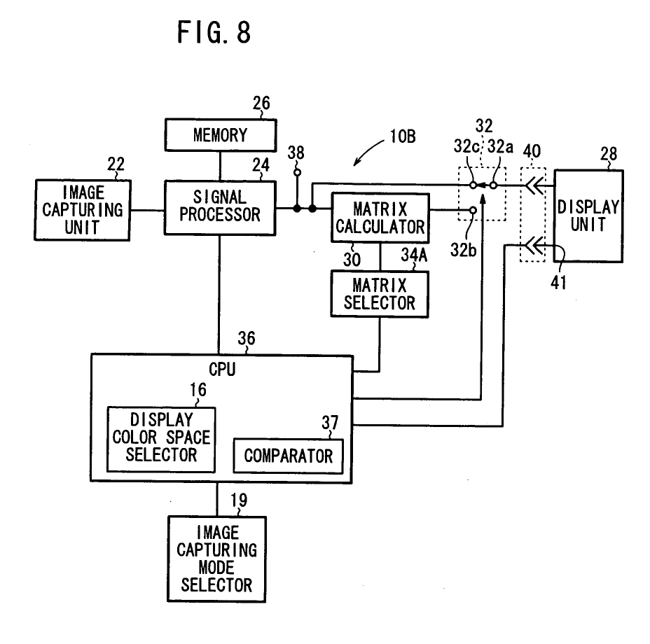

FIG. 8 is a block diagram of an image capturing apparatus 10B according to another embodiment of the present invention. Those parts of the image capturing apparatus 10B, which are identical to or correspond to parts of the image capturing apparatus 10 shown in FIG. 1, are denoted using identical reference characters, and such parts will not be described in detail below. Basically, the image capturing apparatus 10B is different from the image capturing apparatus 10 shown in FIG. 1, with respect to an image capturing mode selector 19, a matrix selector 34A, and the program stored in the ROM of the CPU 36.

The image capturing mode selector 19 selects one of three image capturing modes, i.e., a still image capturing mode, an NTSC moving image capturing mode, and a high-definition moving image capturing mode. The matrix selector 34A can select matrix coefficients, which are to be set in the matrix calculator 30, for converting images from the sRGB color space into the AdobeRGB color space, as well as for converting images from an NTSCRGB (NTSC) color space into the AdobeRGB color space.

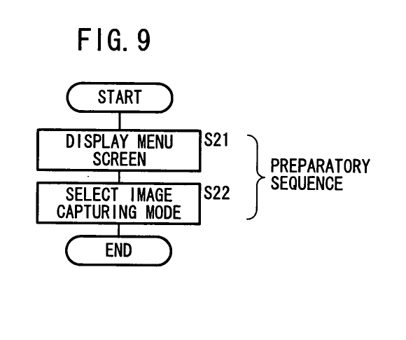

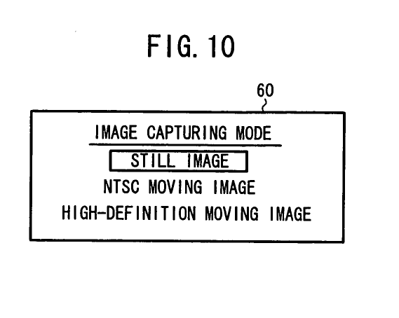

The image capturing apparatus 10B operates in a preparatory sequence, as indicated by a flowchart shown in FIG. 9. The preparatory sequence includes a menu screen display process (step S21) and an image capturing mode selecting process (step S22). When the image capturing apparatus 10B operates in the preparatory sequence, on the menu screen 60 shown in FIG. 10, the user can select one of the still image capturing mode, the NTSC moving image capturing mode, and the high-definition moving image capturing mode, as an image capturing mode in a different target color space.

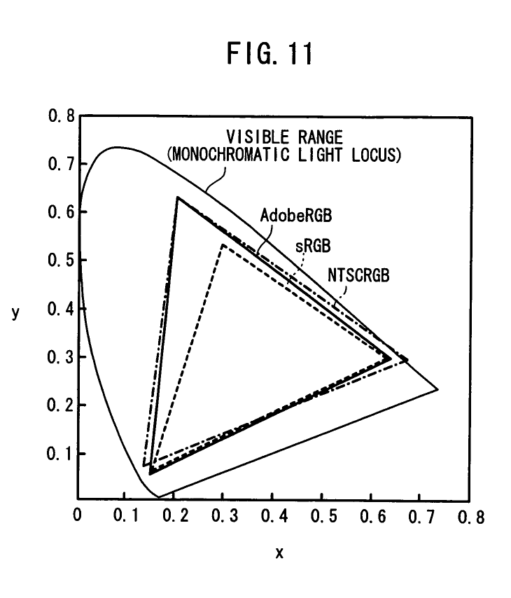

FIG. 11 shows the types of color spaces (also referred to as “color gamuts”) on an xy chromaticity diagram. In FIG. 11, the color space plotted in the shape of a horseshoe by thin solid lines represents a visible range (monochromatic light locus), which is a color gamut including all expected colors, whereas the color space plotted by thick solid lines represents the range of an AdobeRGB color space. The color space plotted by thick dotted lines represents an sRGB color space, and the color space plotted by thick dot-and-dash lines represents an NTSCRGB color space. The target color space for still images corresponds to the sRGB color space, the target color space for NTSC moving images corresponds to the NTSCRGB color space, and the target color space for high-definition moving images corresponds to the AdobeRGB color space. The display color space selector 16 recognizes that the display unit 28, which is connected through the connector 40, corresponds to the AdobeRGB color space.

The display unit 28 can display images in the target color space, corresponding to a selected image capturing mode. It is assumed that the display unit 28 is a display monitor for displaying images in the AdobeRGB color space, i.e., a display monitor corresponding to the AdobeRGB color space, which is capable of displaying images in the AdobeRGB color space only.

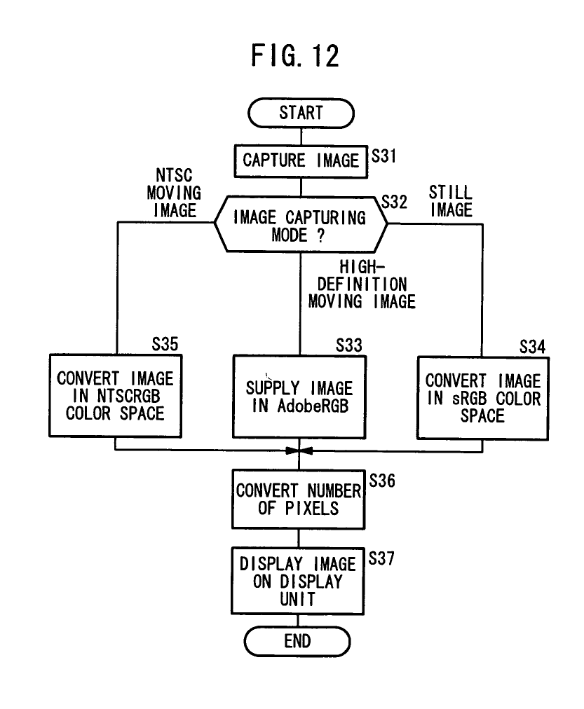

Operations of the image capturing apparatus 10A shall be described below with reference to the flowchart shown in FIG. 12.

In step S31, the user presses the shutter key 18 to capture an image of the subject. Then, the image capturing mode is determined in step S32.

If the user has selected the high-definition moving image capturing mode in step S32, then the signal processor 24 generates an image (digital data) in the AdobeRGB color space, as an image (digital data) in the target color space, which has its colors adjusted to display the image properly on the display unit 28, which is an AdobeRGB monitor. In step S33, the signal processor 24 supplies the image (digital data) in the AdobeRGB color space, as an unconverted to-be-displayed image, directly through the port 32c and the common port 32a of the switcher 32 to the display unit 28. Actually, after the number of pixels of the image is converted in step S36, the image in the AdobeRGB color space, before or after being stored in the memory 26, is displayed as a high-definition moving image on the display unit 28.

If the user has selected the still image capturing mode, then since the signal processor 24 generates an image (digital data) in the sRGB color space as an image (digital data) in the target color space, in step S34, the matrix selector 34A sets the matrix coefficients in the matrix calculator 30 for converting the image from the sRGB color space into the AdobeRGB color space. The matrix calculator 30 converts the image into an image whose colors are adjusted, so as to display the image properly on an external sRGB monitor, and supplies the converted image through the port 32b and the common port 32a to the display unit 28, which displays the image.

If the user has selected the NTSC moving image capturing mode, then in step S35, since the signal processor 24 generates an image (digital data) in the NTSCRGB color space as an image (digital data) in the target color space, the matrix selector 34A sets matrix coefficients for converting the image from the NTSCRGB color space into the AdobeRGB color space in the matrix calculator 30. The matrix calculator 30 converts the image into an image whose colors are adjusted to display the image properly on an external NTSC monitor, and supplies the converted image through the port 32b and the common port 32a to the display unit 28, which displays the image.

The matrix calculator 30 converts the image using the conversion three-row, three-column matrix described above, with respect to equation (1) of the first embodiment.

As shown in FIG. 8, an image capturing apparatus 10B according to another embodiment includes the image capturing mode selector 19 for selecting an image capturing mode in one of different target color spaces, the signal processor 24 for generating an image in the target color space selected by the image capturing mode selector 19, and the display unit 28. The comparator 37 of the CPU 36 compares the target color space of the image capturing mode selected by the image capturing mode selector 19 with the display color space of the display unit 28, in order to determine whether or not they are identical to each other. If it is judged that the target color space of the image capturing mode selected by the image capturing mode selector 19 is different from the display color space of the display unit 28, then the matrix calculator 30 converts the image in the target color space generated by the signal processor 24 into the image in the display color space of the display unit 28.

As described above, the display unit 28 selectively displays the captured image in the target color space of the image capturing mode selected by the image capturing mode selector 19 (the image in the target color space generated by the signal processor 24), or displays the captured image converted into the target color space (the to-be-displayed image converted by the matrix calculator 30 from the image in the target color space generated by the signal processor 24). Therefore, when the selected image capturing mode is changed by the image capturing mode selector 19, the colors of the final image can be predicted from the image displayed on the display unit 28. Stated otherwise, the color reproducibility of the image, in the target color space of the selected image capturing mode, can be predicted from the image displayed on the display unit 28.

The selected image capturing mode may be one of a still image capturing mode, an NTSC moving image capturing mode, and a high-definition moving image capturing mode.

FIG. 13 is a block diagram of an image capturing apparatus 10C according to still another embodiment of the present invention. The image capturing apparatus 10C is similar to the combination of the image capturing apparatus 10, 10B, except that the image capturing apparatus 10C also includes an interchangeable lens (lens unit) 62, which is mounted on the housing of the image capturing apparatus 10C. The interchangeable lens 62 has an identifier 64, which corresponds to and identifies either one of the still image capturing mode, the NTSC moving image capturing mode, and the high-definition moving image capturing mode. The image capturing apparatus 10C can be used in combination with other interchangeable lenses 62 having respective identifiers 64 for identifying the other two of the still image capturing mode, the NTSC moving image capturing mode, and the high-definition moving image capturing mode. The CPU 36 also functions as an image capturing mode selector 19A. When one of the interchangeable lenses 62 is mounted on the housing of the image capturing apparatus 10C, the CPU functions as the image capturing mode selector 19A and selects the image capturing mode depending on the identifier 64 of the mounted interchangeable lens 62. Further, a matrix selector 34B selects a matrix corresponding to the selected image capturing mode. In this manner, the image capturing mode matching the mounted interchangeable lens 62 is selected automatically. The identifier 64 is in the form of a plurality of electronic contacts provided on the interchangeable lens 62 and on the lens mount of the housing of the image capturing apparatus 10C. The image capturing mode selector 19A automatically identifies the image capturing mode of the mounted interchangeable lens 62 through the identifier 64 in the form of such electronic contacts.

Although certain preferred embodiments of the present invention have been shown and described in detail, it should be understood that various changes and modifications may be made to the embodiments without departing from the scope of the invention as set forth in the appended claims.

What is claimed is:

1. An image capturing apparatus comprising:
an image capturing unit for capturing an image of a subject;
a target color space selector for selecting a target color space;
a signal processor for converting the image captured by said image capturing unit into an image in the target color space selected by said target color space selector;
a display color space selector for selecting a display color space;
a comparator for comparing the target color space selected by said target color space selector and the display color space selected by said display color space selector with each other in order to determine whether or not the target color space and the display color space are identical to each other; and
a calculator for converting the image in said target color space into an image in said display color space if said comparator judges that the target color space selected by said target color space selector and the display color space selected by said display color space selector are different from each other.

2. An image capturing apparatus comprising:
an image capturing unit for capturing an image of a subject;
an image capturing mode selector for selecting one of image capturing modes in different target color spaces;
a signal processor for converting the image captured by said image capturing unit into an image in the target color space, corresponding to the image capturing mode selected by said image capturing mode selector;
a display color space selector for selecting a display color space;
a comparator for comparing the target color space corresponding to the image capturing mode selected by said image capturing mode selector and the display color space selected by said display color space selector with each other in order to determine whether or not the target color space and the display color space are identical to each other; and
a calculator for converting the image in said target color space into an image in said display color space selected by said display color space selector if said comparator judges that the target color space corresponding to the image capturing mode selected by said image capturing mode selector and the display color space selected by said display color space selector are different from each other.

3. An image capturing apparatus according to claim 2, further comprising a lens unit having lens identifying information for identifying said lens unit, said lens unit being detachably mounted on said image capturing unit,
wherein said image capturing mode selector selects said one of image capturing modes based on said lens identifying information.

4. An image capturing apparatus according to claim 1, further comprising a storage unit for storing images in said target color space, the image in said target color space being stored in said storage unit.

5. An image capturing apparatus according to claim 2, further comprising a storage unit for storing images in said target color space, the image in said target color space being stored in said storage unit.

6. An image capturing apparatus according to claim 1, further comprising an output terminal for outputting the image in said target color space.

7. An image capturing apparatus according to claim 2, further comprising an output terminal for outputting the image in said target color space.

8. An image capturing apparatus according to claim 1, further comprising a display unit for displaying images in said display color space, the image in said display color space being displayed on said display unit.

9. An image capturing apparatus according to claim 2, further comprising a display unit for displaying images in said display color space, the image in said display color space being displayed on said display unit.

10. An image capturing apparatus according to claim 8, wherein said display unit has identifying information for identifying the display unit, said display unit being detachably mounted, and said display color space selector selects said display color space based on the identifying information of said display unit.

11. An image capturing apparatus according to claim 9, wherein said display unit has identifying information for identifying the display unit, said display unit being detachably mounted, and said display color space selector selects said display color space based on the identifying information of said display unit.
